(19) United States
(12) Patent Application Publication
(10) Pub. No.: US 2024/0042605 A1
(43) Pub. Date: Feb. 8, 2024

(54) Apparatus and a Method for Automatically Programming a Robot to Follow Contours of Objects

(71) Applicants: Mingfeng Zhang, Scarborough (CA); Xing Yuan, Markham (CA)

(72) Inventors: Mingfeng Zhang, Scarborough (CA); Xing Yuan, Markham (CA)

(21) Appl. No.: 17/817,969

(22) Filed: Aug. 5, 2022

(51) Int. Cl. B25J 9/16

(52) U.S. Cl. CPC B25J 9/1664

(57) ABSTRACT

The present disclosure provides an apparatus for automatically programming a robot to follow the contour of an object. One exemplary apparatus includes a 3D perception module for reconstructing a 3D digital model of the surface of objects and a planning software module for generating a path using said 3D digital model for a robot to follow. One aspect of this disclosure provides methods for sensing the geometry of a surface, reconstructing its 3D model, and creating paths for a robot to traverse along the surface.

### RELATED APPLICATIONS

Provisional application No. 63/232,628, filed Aug. 12, 2021.

### FIELD OF THE INVENTION

The present invention relates to a robotic perception and planning control system for and a method of programming a robot to follow contours of objects.

### BACKGROUND OF THE INVENTION

Industrial robots have been widely used in industrial applications and have contributed significantly to increasing productivity. Conventionally, industrial robots are mainly programmed manually with the aid of real workpieces or in a virtual simulation environment. For example, 90% of industrial robotic cells are programmed by using a teaching pedant. Programming a robot using a teaching pedant involves jogging the robots manually to a sequence of points where pre-defined robotic tasks are to be performed, recording the coordinate of each point, and configuring the robot's actions and behaviors at each point and between each pair of consecutive points. This approach is intuitive to use for trained technicians, but it is time-consuming and often requires many rounds of tuning through trial-and-error for complex tasks. Programming via simulation, also known as offline programming, follows similar steps, but everything is done in a virtual mock-up of robots and tasks in simulation software. This helps reduce downtime and improve efficiency because it avoids disrupting robot operations when reprogramming robots for new tasks. However, virtual models are unlikely to match the real world with 100% accuracy, so virtually created robot programs may still need some fine tuning before being deployed to real robots.

Given the amount time required to create and perfect robot programs by these two methods, they are more suitable for the so-called “low-variation, high volume” tasks that involve repetitive workpieces in mass production. For this type of applications, robots are expected to repetitively perform prescribed tasks on the same type of workpieces, and there is no need to change them frequently. Since robot programs do not have to change once they are properly created and tested, spending a significant amount of time upfront on perfecting them is acceptable. However, these methods are not suitable for applications with “high-variation, low volume” workpieces, where robots are expected to perform prescribed tasks on workpieces that change frequently. Reprograming robots every time when there is a new workpiece is economically prohibitive for mass production. Therefore, there is a need to develop an improved method that can automatically program robots to follow the contour of any given workpieces.

### SUMMARY OF THE INVENTION

The present disclosure provides a system that integrates on-board perception and planning function to robots. This function enables a robot to sense and model a given workpiece using onboard perception sensor. The sensed information is then used to automatically program the robot to follow the contour of the workpiece to perform prescribed tasks on it. One exemplary system consists of at least a perception sensor that is attached to a robot such as an industrial robot arm and a computer that is interfaced with said perception sensor and said robot's controller. In a preferred embodiment, the perception sensor is a 3D sensor that acquires point clouds of the surface of a workpiece. The perception sensor is interfaced with said computer, where a piece of software receives the point clouds form the perception sensors and creates a 3D model of the surface from the point clouds. This software detects obstacles on the surface and generates a path for the robot arm, which contains a plurality of waypoints along the periphery of the surface. The software further validates the poses in the path to identify and correct unfeasible and unsafe ones before passing the path to the robot's controller. This path can guide the robot to follow the contour of the workpiece to perform prescribed tasks on it. Exemplary operations may include inspection, welding, gluing, milling, grinding, cleaning, painting, and de-painting.

One aspect of this disclosure provides methods for a robot to model a given workpiece using onboard perception sensors and using the sensed information to program itself to perform prescribed tasks on the workpiece.

### DESCRIPTION OF DRAWINGS

Embodiments will now be described, by way of example only, with reference to the drawings, in which:

FIG. 1 shows a block diagram of the components of the onboard perception and planning system according to an embodiment of the invention.

FIG. 2 shows the operational steps for on-board path planning for a robot arm according to an embodiment of the invention.

FIG. 3 shows the operational steps for generating a 3D model based acquired point clouds of a workpiece according to an embodiment of the invention.

FIG. 4 shows the operational steps for planning a robot arm's path based on a 3D model of a workpiece to perform prescribed tasks on patches on the workpiece according to an embodiment of the invention.

FIG. 5 shows a robot path corresponding to a set of ordered waypoints for a surface according to an embodiment of the invention.

FIG. 6 shows the operational steps for planning a robot arm's path based on a 3D model of a workpiece to perform prescribed tasks on a line on the workpiece according to an additional embodiment of the invention.

FIG. 7 shows the operational steps for modifying a robot arm's path to avoid obstacles by adding intermediate waypoints according to an embodiment of the invention.

FIG. 8 shows an example of a modified path for a robot arm to avoid obstacles by adding intermediate waypoints according to an embodiment of the invention.

FIG. 9 shows the operational steps for modifying a robot arm's path to avoid obstacles by adding a home waypoint according to an additional embodiment of the invention.

FIG. 10 shows an example of a modified path for a robot arm to avoid obstacles by adding a home waypoint according to an additional embodiment of the invention.

### DETAILED DESCRIPTION OF THE INVENTION

Various embodiments and aspects of the disclosure will be described with reference to details discussed below. The following description and drawings are illustrative of the disclosure and are not to be construed as limiting the disclosure. The drawings are not necessarily to scale. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps, or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

As used herein, the term “work envelope” or “reach envelope” refers to a 3D shape that defines the boundaries that a robot's end effector can reach.

As used herein, the term “position and orientation” refers to an object's coordinates with respect to a fixed point together with its alignment (or bearing) with respect to a fixed axis. For example, the position and orientation of a motion platform might be the coordinates of a point on the motion platform together with the bearing of the motion platform (e.g., in degrees). The term “waypoint” is used interchangeably as a short form for “position and orientation”.

As used herein, the term “path” or “path of a robot arm” refers to a sequence of waypoints (i.e., position and orientation) for a robot.

The present disclosure relates to an apparatus that provides onboard perception and planning capability for a robot to perform prescribed tasks on a workpiece. As required, preferred embodiments of the invention will be disclosed, by way of examples only, with reference to drawings. It should be understood that the invention can be embodied in many various and alternative forms. In other instances, well-known methods, procedures, and components have not been described in detail so as not to obscure the embodiments described herein. Also, the description is not to be considered as limiting the scope of the embodiments described herein.

The robotic perception and planning system as claimed provides a beneficial solution for enabling a robot to automatically program its path for a given workpiece. The onboard perception sensor allows the robot to sense a workpiece without prior knowledge and capture point clouds of the workpiece. A piece of software interfaced with the perception sensors to receive the measured point clouds and create a 3D CAD model of the work piece. This software generates a safe and feasible path using the 3D model which guides the robot to visit a plurality of positions along the periphery of the workpiece to perform prescribed operations. The robots for which the present invention is intended may be any moveable machines that is capable of moving a tool to perform pre-defined tasks, including robot arms, linear stages, and gantry systems.

The structure of the system that provides onboard perception and programing for a robot arm will first be described.

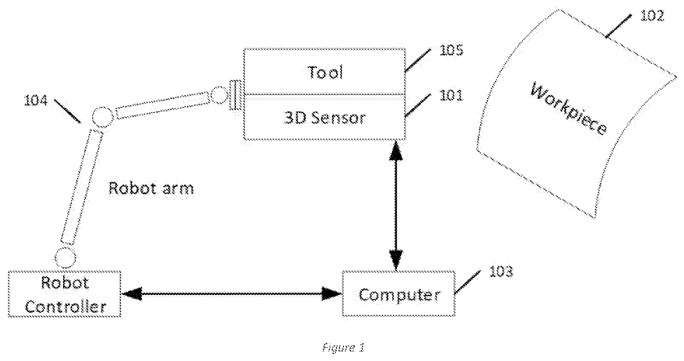

Referring to FIG. 1, the robotic perception and planning system is shown generally according to one embodiment. Said system comprises a 3D sensor 101 for acquiring point clouds of a given workpiece 102 and a computer 103 for running software to process point clouds acquired by said 3D sensor and generating one or more paths for a robot arm 104 that carries a tool 105 for perform tasks on said workpiece 102. Said 3D sensor 101 is attached to the end of the robot arm 104, and said computer 103 is interfaced with said 3D sensor 101 and said robot arm 104. The 3D sensor 101 could be one of a passive stereo 3D sensor, an active stereo 3D sensor, a structured light 3D sensor, or a time-of-flight 3D sensor. During operation, the robot arm 104 positions the 3D sensor 101 to one or more vantage positions around the workpiece 102 to observe it. The 3D sensor 101 captures one or more point clouds of the workpiece 102 at each position. If the workpiece 102 is larger than the field of view of the 3D sensor 101, the robot arm 104 moves it to one or more positions around the workpiece to achieve desired coverage. A piece of software running on said computer 103 receives the acquired point clouds and merges them into one 3D model of the workpiece 102. Said software detects obstacles using the acquired 3D model of the workpiece 102 and generates a sequence of waypoints for the robot arm 104 to traverse the surface of the workpiece 102 to perform prescribed tasks. Said software further examines each waypoint to determine whether they are safe and feasible for the robot arm. If a waypoint is found unsafe or unfeasible, said software corrects it or eliminates it from the path before passing the path data to the robot arm's controller.

In an additional embodiment of the robotic perception and planning system, the perception sensor may be a line scanner that projects a line of light to the surface of a workpiece and measures its distance to a plurality of points on a line on the workpiece based on the time-of-flight principle.

In an additional embodiment of this invention, the perception sensor may be mounted on a separate movable machine as opposed to the robot that performs the robotic tasks.

The method of the present robotic perception and planning system includes multiple operational steps.

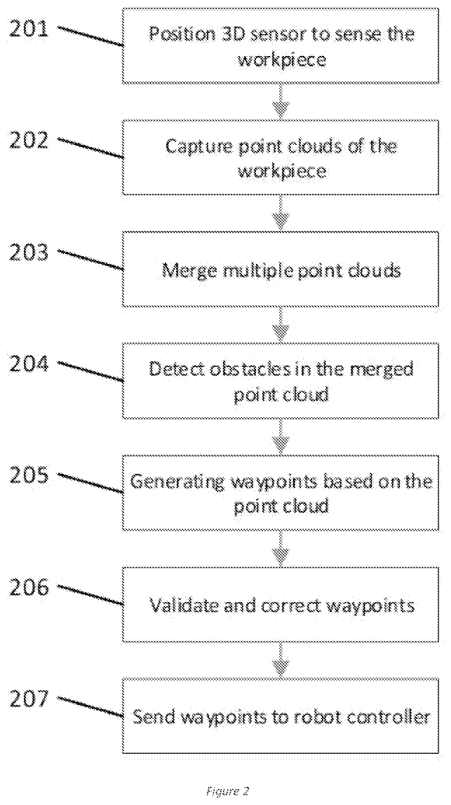

Referring to FIG. 2, the operational workflow of using onboard perception and planning to program a robot arm is shown according to one embodiment. In step 201 the robot arm carrying the 3D sensor moves it one or more positions around the workpiece. In step 202, the 3D sensor captures one ore more point clouds of the surface of the workpieces at each position. Then the point cloud or point clouds are merged into to a 3D model of the workpiece in step 203, and obstacles are then detected using this mode according to predefined criteria in step 204. Step 205 involves generating a sequence of waypoints which can guide the robot arm to traverse through the surface of the workpiece, where each waypoint defines a pose (i.e., position and orientation) of the robot arm. Step 206 examines each waypoint to determine if it is safe and feasible for the robot arm. A safe waypoint should be free of obstacles. A feasible waypoint should be within the work envelope of the robot arm and be free of singularity of the robot arm. If a waypoint is found unsafe or unfeasible, the closest safe and feasible alternative is calculated to replace it. In step 207 the validated path is sent to the controller of the robot arm.

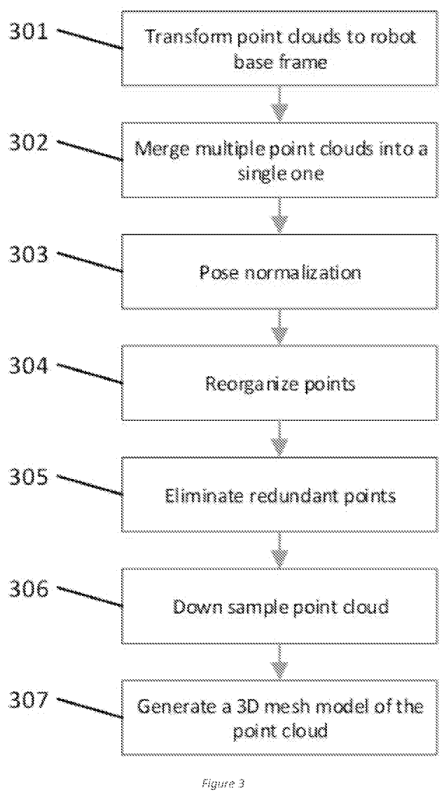

Referring to FIG. 3, the workflow of step 203 according to one embodiment of this invention for generating a 3D model from point clouds comprises the following sub-steps. In step 301, the acquired multiple point clouds are transformed from said 3D sensor's coordinate frame to the robot base frame that is fixed to the robot's base. The transformation from the 3D sensor's frame to the robot's base frame can be found in a variety of ways. In one embodiment of this invention, the transformation is found through an experimental process, which is known as calibration. Once all the point clouds are transformed into the same coordinate frame attached to the robot's base, they are then merged into one single point cloud in step 302. Subsequently, an operation called pose normalization is performed on the merged point cloud in step 303 to determine its principal axes. A variety of techniques, such as the principal component analysis method and its variants, could be used for this operation. Then in Step 304 the points are re-organized in a frame defined by the principal axes. This could be done by first creating a virtual image plane that is parallel to the first two dominant axes of the principal axes and then projecting all points to the pixels of said virtual image plane. After this process, some pixels may contain more than one point. In step 305, redundant points in each pixel are eliminated. Specifically, only the point with the shortest distance to the center of the virtual image plan should be retained in each pixel, and the other points should be removed. The merged point cloud may be optionally down-sampled in step 306 to reduce its size and the computational load in subsequent processing steps. Afterwards, in step 307 said point cloud is converted into a 3D mesh model which consists of vertices, edges, and faces that use polygonal representation, including triangles and quadrilaterals, to define a 3D shape.

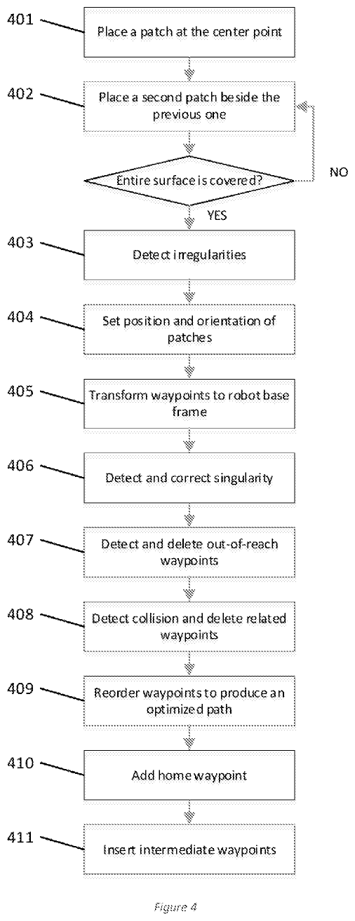

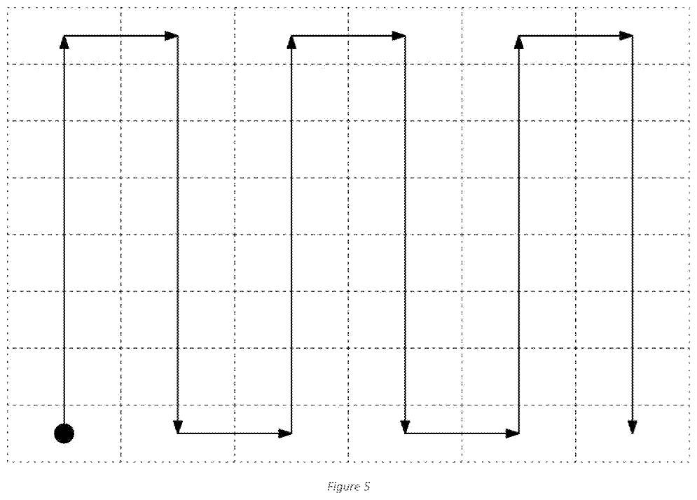

Planning a path for a robot arm to perform a task on a workpiece may be performed in a variety of ways depending on the nature of the task. In one type of tasks where the robot arm's tool is required to perform some operation on a small patch on the workpiece's surface at time. The path planning problem for this type of task involves dividing the surface of a workpiece into a plurality of patches and generating a set of feasible and safety waypoints for the robot arm to visit each patch in sequence. Referring to FIG. 4, the workflow of planning the robot path for this type of tasks according to one embodiment of this invention comprises the following steps. In step 401, a patch is placed at the center point of on the surface of the 3D model generated in the step 203. In step 402, a second patch is placed beside the first patch along one of the two dominant principal axes of the 3D point cloud. This step is repeated until the entire surface is covered by patches. Step 403 involves detecting obstacles based pre-defined criteria, area with insufficient points, and other irregularities and removing patches that overlap with these areas. Step 404 involves setting the orientation of each patch to be tangent to the portion of the workpiece's surface corresponding to each patch. Therefore, the center point of each patch and its orientation define a waypoint for the robot arm to visit the patch. In steps 405, the waypoints are transformed to the robot's base frame. Step 406 involves detecting singularity in the waypoints, which could be done by examining the Jacobian matrix of the robot arm, and applying corrections to the waypoints with singularity. Step 407 involves detecting waypoints that are outside the work envelope of the robot arm and deleting these our-of-reach waypoints. Step 408 detecting and deleting waypoints that are colliding with any portion of the surface. In steps 409, all the waypoints are ordered to optimize the traversing path of the robot to visit them. An exemplary ordered set of waypoints for a surface is shown in FIG. 5. Step 410 adds a home waypoint which will be the starting and ending waypoint of this sequence of waypoints. Step 411 involves inserting intermediate waypoints between the waypoints through interpolating each pair of two consecutive waypoints. The final set of waypoints are then sent to the robot arm's controller.

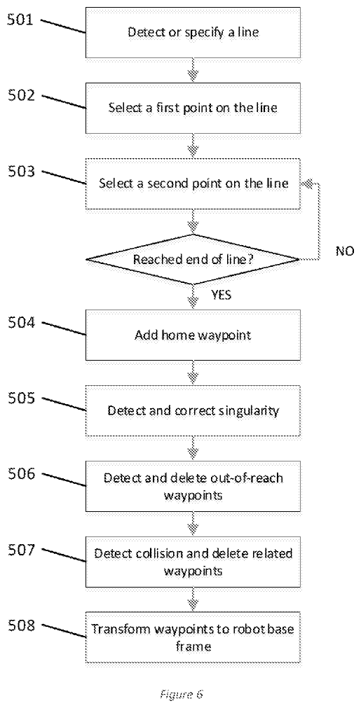

In another type of robotic tasks, the robot arm is required to perform a prescribed operation along a line on the surface of a workpiece. Referring to FIG. 6, the workflow of planning the robot path for this type of tasks according to one embodiment of this invention comprises the following steps. In Step 501, the line is detected by using onboard perception sensor based on prescribed criteria or specified by an operator. In Step 502, the first point at one end of the line is selected. In step 503, a second point between the first point and the other end of the line and is at a prescribed distance from the first point is selected. This step is repeated until the other end of the line is reached. Step 504 adds a home waypoint which will be the starting and ending waypoint of this sequence of waypoints. Step 505 involves detecting singularity in the waypoints by examining the Jacobian matrix of the robot arm and applying corrections to the waypoints with singularity. Step 506 involves detecting waypoints that are outside the work envelope of the robot arm and deleting these our-of-reach waypoints. Step 507 involves detecting and deleting waypoints that are colliding with any portion of the surface. In step 508, the pose of each waypoint is transformed into the robot's base frame.

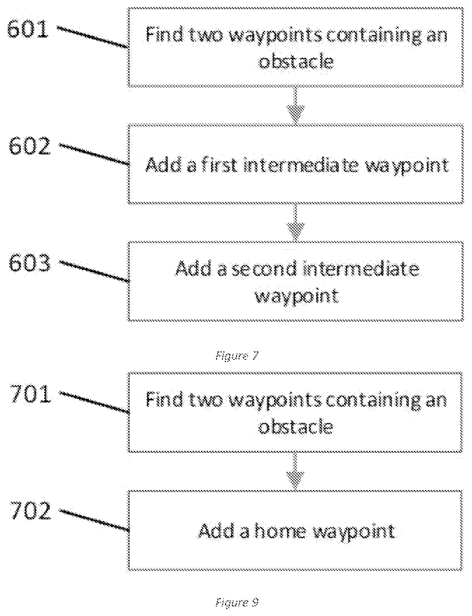

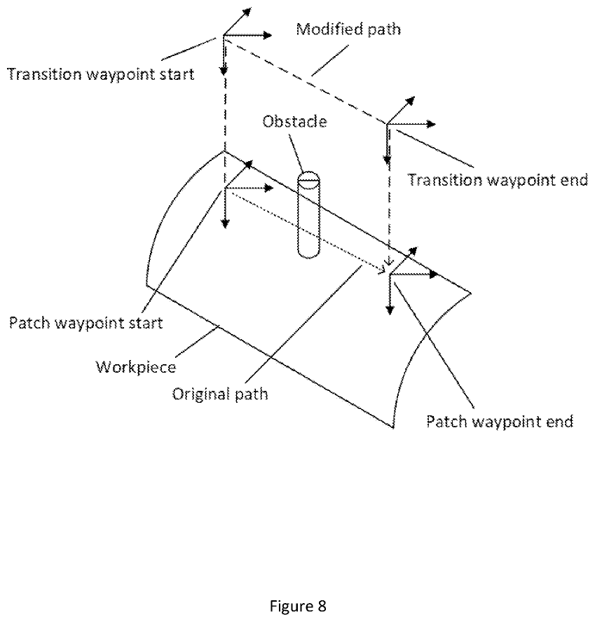

Referring to FIG. 7, the workflow of modifying a robot arm's path to avoid obstacles comprises the following steps according to one embodiment of this invention. Step 601 finds the two waypoints that have an obstacle between them. Step 602 adds a first intermediate waypoint to the path which is above the first waypoint and higher than the obstacle. Step 603 adds a second intermediate waypoint to the path which is above the second waypoint and higher than the obstacle. An exemplary modified path is shown in FIG. 8.

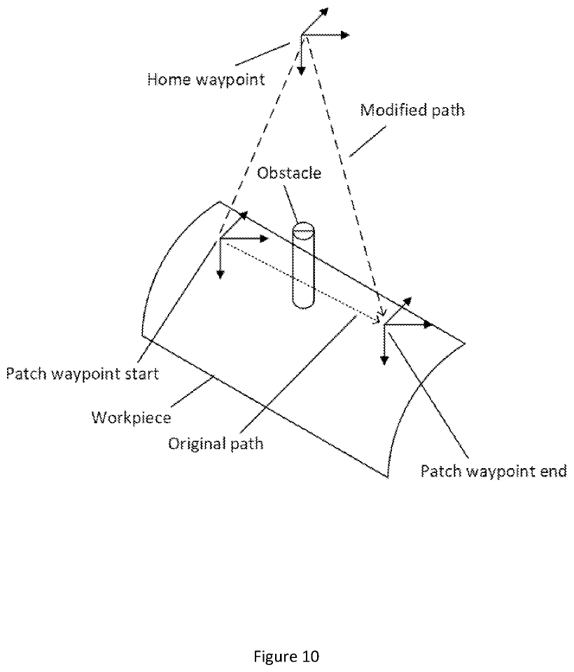

Referring to FIG. 9, the workflow of modifying a robot arm's path to avoid obstacles comprises the following steps according to an additional embodiment of this invention. Step 701 finds the two waypoints that have an obstacle between them. Step 702 adds the home waypoint to the path. An exemplary modified path is shown in FIG. 10.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Therefore, what is claimed is:

1. An apparatus for providing automatic programming for a robot to follow the contour of an object, comprising:
one or more 3D sensors; and
a computing device interfaced with said one or more 3D sensors and said robot and is programmed with instructions to automatically program said robot to follow the contour of an object, comprising the steps of:
commanding said robot to position one or more 3D sensors to sense the object;
commanding said 3D sensors to capture a plurality of 3D point clouds of said object's surface;
merging said 3D point clouds into one 3D point cloud;
detecting obstacles in the merged 3D point cloud;
generating robot waypoints; and
validating robot waypoints and applying corrections on waypoints with potential collision with the object; and
sending said waypoints to the robot's controller.

2. A method for a robot to automatically program its motion to follow the contour of an object, comprising the steps of:
commanding said robot to position one or more 3D sensors to sense the object;
commanding said 3D sensors to capture a plurality of 3D point clouds of said object's surface;
merging said 3D point clouds into one 3D point cloud;
detecting obstacles in the merged 3D point cloud;
generating robot waypoints; and
validating robot waypoints and applying corrections on waypoints with potential collision with the object.

3. The method according to claim 2, wherein the step of merging multiple 3D images into one image comprises the steps of:
transforming point clouds into the coordinate frame associated with the robot's base;
combining all the transformed point clouds into one single point cloud;
determining the principal axes of the merged point cloud;
reorganizing points in a new coordinate frame that is constructed using said principal axes;
removing redundant points in the point cloud;
down sampling the point cloud to reduce the number of points in the point cloud; and
generating a 3D mesh model of the point cloud.

4. The method according to 2, wherein the step of generating robot waypoints to follow the contour of an object comprises the steps of:
placing a patch at the centre point of a 3D mesh model of the surface of said object;
placing a second patch beside the previous patch along one of the two dominant principal axes of the 3D point cloud and repeating this step until the entire surface are covered by patches;
detecting irregular objects on the 3D model, including obstacles based on pre-defined criteria, areas with insufficient points, and removing patches with overlap with these objects;
setting the orientation of each patch to be tangent to the portion of surface corresponding to each patch and setting the center point of the patch and its orientation as a robot waypoint for this patch;
transforming the waypoints into the coordinate frame that is attached to the robot's base;
detecting singularity in the waypoints and applying correction to such waypoints;
detecting and deleting any waypoints that are colliding with any portion of the surface;
optimizing the ordering the robot waypoints to reduce the robot's time to traverse them;
adding a home waypoint to serve as the starting and ending positions for the robot to visit the waypoint sequence; and
inserting intermediate waypoints between waypoints through interpolating each pair of two consecutive waypoints.

5. The method according to claim 2, wherein the step of automatically generating waypoints for robot to follow a line on a surface comprises the steps of:
detecting the line using onboard perception sensors;
selecting the point at one end of the line;
selecting a second point between the previous point and the other end of the line at a prescribed distance and repeating this step until the other end point of the line is reached;
adding a home waypoint to serve as the starting and ending positions of the waypoint sequence;
detecting waypoints with singularity and applying corrections to these waypoints;
detecting and deleting waypoints that are out of the reach of the robot;
detecting and deleting waypoints that are colliding with any portion of the surface; and
transforming the waypoints into the coordinate frame that is attached to the robot's base.

6. The method according to 2, wherein the step of modifying a robot's path to avoid one or more obstacles comprises the steps of:
finding two waypoints that have one ore more obstacles between them;
adding a first intermediate waypoint to the path that is above the first waypoint and higher than the obstacles; and
adding a second intermediate waypoint to the path that is above the second waypoint and higher than the obstacles.
